(19) United States
(12) Patent Application Publication
(10) Pub. No.: US 2026/0028483 A1
(43) Pub. Date: Jan. 29, 2026

(54) COLORING COMPOSITION FOR COLOR FILTERS AND METHOD OF MANUFACTURING THE SAME, AND COLOR FILTER FOR IMAGE SENSORS MANUFACTURED USING THE COLORING COMPOSITION FOR COLOR FILTERS

(71) Applicant: Samsung Electronics Co., Ltd., Suwon-si (KR)

(72) Inventors: Hyojeong Yoo, Suwon-si (KR); Jae Pil Kim, Seoul (KR); Jin Young Kim, Seoul (KR); Wan Soo Kim, Seoul (KR); So Jeong Park, Seoul (KR); Jeongju Park, Suwon-si (KR); Cheolsang Yoon, Suwon-si (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/268,304

(22) Filed: Jul. 14, 2025

(30) Foreign Application Priority Data
Jul. 25, 2024 (KR) 10-2024-0098980
Nov. 22, 2024 (KR) 10-2024-0168907

(51) Int. Cl. C09B 67/42; C09B 29/08; C09B 57/00; G02B 5/22

(52) U.S. Cl. CPC C09B 67/0095; C09B 29/0802; C09B 57/001; C09B 57/004; G02B 5/223

(57) ABSTRACT

A coloring composition for a color filter, a method of manufacturing the same, and a color filter for an image sensor manufactured using the coloring composition for a color filter are provided. The coloring composition includes a coloring composite including: a nanoparticle including a metal oxide or a non-metal oxide; and a colorant adsorbed on a surface of the nanoparticle, wherein the colorant includes one selected from a perylene compound including a carboxyl group (—COOH) at the para position of a benzene ring, a diketopyrrolopyrrole compound including a carboxyl group (—COOH) at the para position of a benzene ring, and an azo compound including a carboxyl group (—COOH) at the para position of a benzene ring.

### CROSS-REFERENCE TO RELATED APPLICATIONS

This application is based on and claims priority under 35 USC § 119 to Korean Patent Application Nos. 10-2024-0098980, filed on Jul. 25, 2024, and 10-2024-0168907, filed on Nov. 22, 2024, in the Korean Intellectual Property Office, the disclosures of which are incorporated by reference herein in their entirety.

### FIELD

The inventive concept relates to a coloring composition for a color filter and a method of manufacturing the same, and a color filter manufactured using the coloring composition for a color filter, and more specifically, to a coloring composition used for a color filter for an image sensor and a method of manufacturing the same, and a color filter for an image sensor manufactured using the coloring composition for a color filter.

### BACKGROUND

An image sensor is a device that consists of millions of photoelectric conversion elements that converts light into electrical signals based on the amount of light received. Such image sensors are used in digital input devices to enable recording of pre-digital state images as digital images, and with the rapidly changing developments of the times, their demand is increasing exponentially for use as various security devices and digital porters.

An image sensor consists of a pixel array, that is, multiple pixels arranged in a two-dimensional matrix form, and each pixel includes photodetection elements and transmission and signal output devices. According to the transmission and signal output devices, image sensors are largely classified as two types: charge-coupled device (CCD)-type image sensors and complementary metal-oxide-semiconductor (CMOS)-type image sensors. The color filter in the image sensor is used to separate incoming light from the outside into respective R, G, and B and transmit the same to the photodiode corresponding to each pixel.

Coloring compositions used in image sensor color filters of the related art have poor light resistance and heat resistance, and thus, there is a need for a coloring composition with improved reliability through enhanced photostability and heat stability.

### SUMMARY

The inventive concept provides a coloring composition for a color filter, the coloring composition having improved reliability through improved photostability and heat stability.

The inventive concept provides a method of manufacturing a coloring composition for a color filter, the coloring composition having improved reliability by improving photostability and heat stability.

However, the problems to be solved by the inventive concept are not limited to the problems described above, and other problems may be clearly understood by those skilled in the art from the description below.

According to an aspect of the inventive concept, there is provided a coloring composition for a color filter, including a coloring composite including: a nanoparticle including a metal oxide or a non-metal oxide; and a colorant adsorbed on the surface of the nanoparticle, wherein the colorant includes one selected from a perylene compound including a carboxyl group (—COOH) at the para position of a benzene ring, a diketopyrrolopyrrole compound including a carboxyl group (—COOH) at the para position of a benzene ring, and an azo compound including a carboxyl group (—COOH) at the para position of a benzene ring.

According to another aspect of the inventive concept, there is provided a method of manufacturing a coloring composition for a color filter, including: providing nanoparticles including a metal oxide or non-metal oxide (e.g., titanium dioxide (TiO₂)); providing a colorant; and synthesizing a coloring composite in which the colorant is adsorbed on the surface of the nanoparticles, wherein the colorant includes a compound represented by one of Formula 2, Formula 3, and Formula 4. In some embodiments, the providing the nanoparticle comprises synthesizing the nanoparticle. In some embodiments, the providing the colorant comprises synthesizing the colorant.

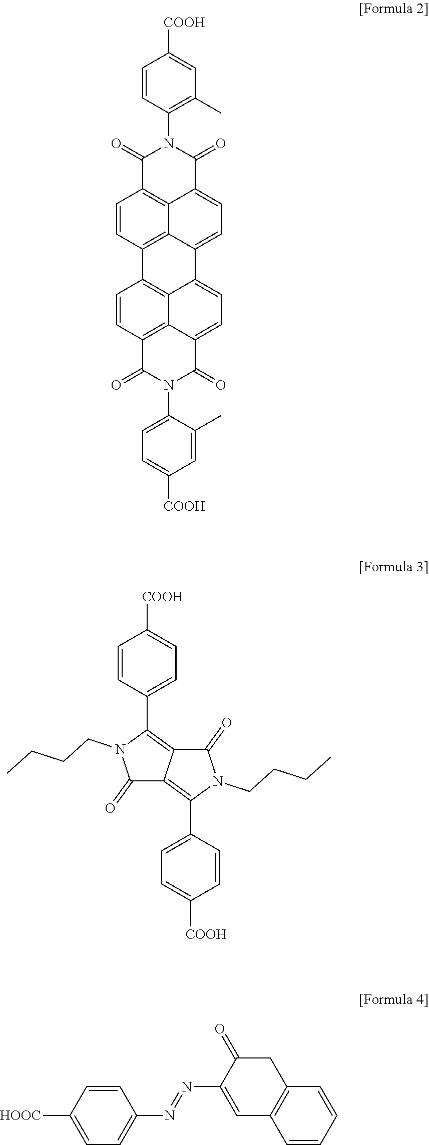 [SMILES: Cc1cc(C(=O)O)ccc1N1C(=O)c2ccc3c4ccc5c6c(ccc(c7ccc(c2c37)C1=O)c64)C(=O)N(c1ccc(C(=O)O)cc1C)C5=O ; CCCCN1C(=O)C2=C(c3ccc(C(=O)O)cc3)N(CCCC)C(=O)C2=C1c1ccc(C(=O)O)cc1 ; O=C1Cc2ccccc2C=C1/N=N/c1ccc(C(=O)O)cc1]

According to another aspect of the inventive concept, there is provided a coloring composition for a color filter, which includes a coloring composite including nanoparticles including titanium dioxide (TiO₂); and a colorant adsorbed on the surface of the nanoparticles, wherein the colorant includes a compound represented by one of Formula 2, Formula 3, and Formula 4, and the coloring composite has a transmittance of about 85% to about 100% in a wavelength range from about 550 nm to about 750 nm.

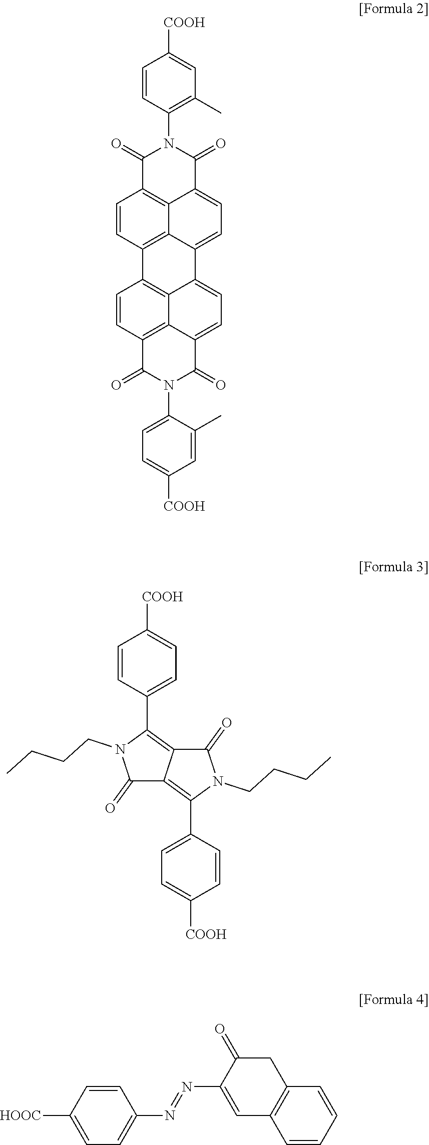 [SMILES: Cc1cc(C(=O)O)ccc1N1C(=O)c2ccc3c4ccc5c6c(ccc(c7ccc(c2c37)C1=O)c64)C(=O)N(c1ccc(C(=O)O)cc1C)C5=O ; CCCCN1C(=O)C2=C(c3ccc(C(=O)O)cc3)N(CCCC)C(=O)C2=C1c1ccc(C(=O)O)cc1 ; O=C1Cc2ccccc2C=C1/N=N/c1ccc(C(=O)O)cc1]

### BRIEF DESCRIPTION OF THE DRAWINGS

Embodiments will be more clearly understood from the following detailed description taken in conjunction with the accompanying drawings in which:

FIG. 1 shows a diagram for an example embodiment of a coloring composite included in a coloring composition for a color filter of the inventive concept;

FIGS. 2A, 2B and 2C include diagrams of example embodiments of the anatase phase of nanoparticles included in the coloring composition for a color filter of the inventive concept;

FIGS. 3A, 3B, and 3C include diagrams of the rutile phase of nanoparticles according to example embodiments included in the coloring composition for a color filter of the inventive concept;

FIG. 4 includes a graph of exemplary results of thermal gravimetric analysis (TGA) of the coloring composition for a color filter of the inventive concept;

FIG. 5 includes a graph showing the transmittance spectrum of a coloring composition according to example embodiments for a color filter of the inventive concept;

FIG. 6 includes a graph showing the relative absorbance over time of a coloring composition for a color filter including only either the coloring structure or the colorant of example embodiments of the inventive concept; and

FIG. 7A and FIG. 7B include graphs of measurements of the relative absorbance according to temperature of the coloring composition for a color filter of example embodiments of the inventive concept.

### DETAILED DESCRIPTION OF THE EMBODIMENTS

Hereinafter, embodiments of the inventive concept will be described in detail with reference to the attached drawings. The same reference symbols are used for identical components in the drawings, and duplicate descriptions of these are omitted.

### Coloring Composite

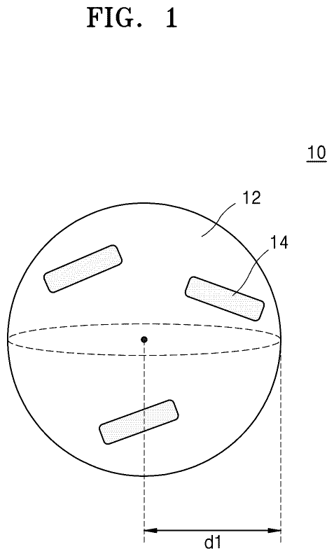

FIG. 1 shows a diagram for explaining a coloring composite 10 included in a coloring composition for a color filter of the inventive concept.

Referring to FIG. 1, the coloring composite 10 included in the coloring composition for a color filter of the inventive concept may include a nanoparticle 12 with a radius d1 and a colorant 14 adsorbed on the surface of the nanoparticle 12.

In embodiments, the coloring composite 10 may be included in a coloring composition for a red color filter and may have a transmittance of about 85% to about 100%, or any range therein, in a wavelength range of about 550 nm to about 750 nm.

In embodiments, the coloring composite 10 may have a transmittance of about 85% to about 100%, or any range therein, in a wavelength range of about 550 nm to about 750 nm even after being heat treated at about 230 degrees Celsius for about 1 hour or at about 300 degrees Celsius for about 5 minutes.

In embodiments, the nanoparticle 12 may be a white particle. For example, the nanoparticle 12 may include metal oxide or non-metal oxide. For example, the nanoparticle 12 may include a material selected from the group consisting of titanium dioxide (TiO₂), zirconium dioxide (ZrO₂), indium tin oxide (ITO), chromium oxide (CrO), iron oxide (FeO), lead oxide (PbO), nickel oxide (NiO), cadmium oxide (CdO), magnesium oxide (Mgo), or a combination thereof. In some embodiments, the nanoparticle 12 may include titanium dioxide. For example, the nanoparticle 12 may include titanium dioxide having a crystal phase of either an anatase phase or a rutile phase. Hereinafter, the nanoparticle 12 including titanium dioxide may be referred to as a titanium dioxide nanoparticle.

In some embodiments, the nanoparticle 12 may be manufactured through a precipitation method and a hydrothermal synthesis method, or may be manufactured only through a hydrothermal synthesis method. For example, for titanium dioxide nanoparticles, the nanoparticle 12 manufactured through the precipitation method and the hydrothermal synthesis method may have an anatase phase, and the nanoparticle 12 manufactured through the hydrothermal synthesis method may have a rutile phase.

In some embodiments, a radius d1 of the nanoparticle 12 may be in a range of about 0.01 nanometers to 30 nanometers, or any range therein, for example, about 0.01 nanometers to 15 nanometers.

In embodiments, the colorant 14 may be a red colorant, and a dye that may be easily adsorbed onto the surface of the nanoparticle 12 may be used as the colorant 14. For example, the dye may be an organic dye having a functional group capable of being adsorbed onto the surface of nanoparticle 12. In some embodiments, the dye may be an anionic or anion-forming organic dye. For example, the dye may include a carboxyl group (—COOH) in the molecule.

In some embodiments, the colorant 14 may include one selected from a perylene compound including a carboxyl group (—COOH) at the para position of a benzene ring, a diketo pyrrolopyrrole compound including a carboxyl group (—COOH) at the para position of a benzene ring, and an azo compound including a carboxyl group (—COOH) at the para position of a benzene ring.

In some embodiments, when the colorant 14 includes the perylene compound, the colorant 14 may include a compound represented by Formula 1.

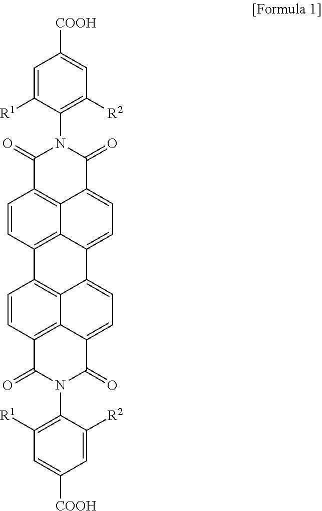

In some embodiments, R¹ and R² in Formula 1 may each independently represent hydrogen or a C1 to C4 alkyl group.

In some embodiments, when the colorant 14 includes the perylene compound, the colorant 14 may include a compound represented by Formula 2.

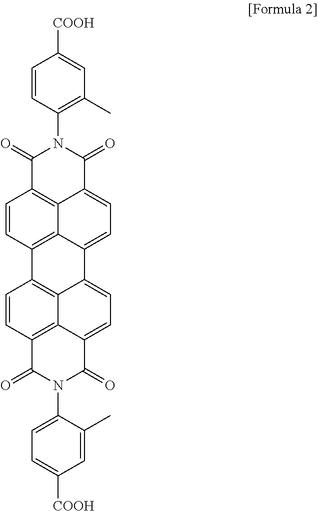 [SMILES: Cc1cc(C(=O)O)ccc1N1C(=O)c2ccc3c4ccc5c6c(ccc(c7ccc(c2c37)C1=O)c64)C(=O)N(c1ccc(C(=O)O)cc1C)C5=O]

In some embodiments, when the colorant 14 includes the diketopyrrolopyrrole compound, the colorant 14 may include a compound represented by Formula 3. Alternatively, when the colorant 14 includes the azo compound, the colorant 14 may include a compound represented by Formula 4.

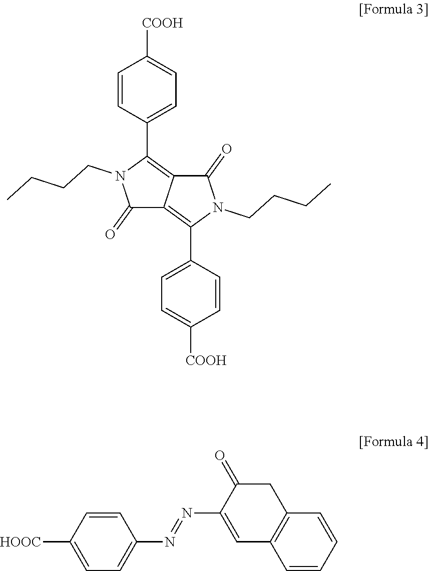 [SMILES: CCCCN1C(=O)C2=C(c3ccc(C(=O)O)cc3)N(CCCC)C(=O)C2=C1c1ccc(C(=O)O)cc1 ; O=C1Cc2ccccc2C=C1/N=N/c1ccc(C(=O)O)cc1]

In some embodiments, the colorant 14 may be adsorbed onto the surface of the nanoparticle 12, and the adsorption may include physisorption and/or chemisorption. For example, the physisorption may include adsorption of the colorant 14 onto the surface of the nanoparticle 12 via Van Der Waals forces and/or hydrogen bonding, and the chemisorption may include adsorption of the colorant 14 onto the surface of the nanoparticle 12 via bonding of a functional group included in the colorant 14 (e.g., a carboxyl group (—COOH) included in the colorant 14).

In some embodiments, when the colorant 14 is physisorbed on the surface of nanoparticle 12, the colorant 14 may lie on the surface (e.g., in the same plane) of nanoparticle 12, and when chemisorbed, the colorant 14 may stand vertically on the surface of nanoparticle 12. In some embodiments, the colorant 14 is adsorbed on the surface of nanoparticle 12 through competitive interactions of physisorption and chemisorption to form the coloring composite 10, a structure in which the colorant 14 lies horizontally (e.g. the long axis of the colorant lies approximately in the same plane) on the surface of nanoparticle 12 and a structure in which colorant 14 stands upright from the surface (e.g., vertically or an angle measuring between about 45° to 135° relative to the surface) of nanoparticle 12 may coexist, e.g., colorant 14 can lie vertically and horizontally on the surface of the same nanoparticle 12, and/or a nanoparticle 12 comprising colorant 14 lying horizontally and/or a nanoparticle 12 comprising colorant 14 standing vertically can form the coloring composite.

In some embodiments, the colorant 14 may be adsorbed at a rate of about 0.001 (mM/g) to about 0.05 (mM/g), or any range therein, for example, 0.005 mM/g to 0.05 mM/g, 0.001 mM/g to 0.025 mM/g, or 0.01 to 0.03 mM/g, per mass of the nanoparticle 12. When comparing the amount of the colorant 14 chemisorbed on the surface of nanoparticle 12 (hereinafter referred to as the chemisorption amount) with the amount of the colorant 14 physisorbed (hereinafter referred to as the physisorption amount), the chemisorption amount may be relatively greater than the physisorption amount, and for example, the chemisorption amount may be about 2 times to about 5 times the physisorption amount.

In some embodiments, the adsorption energy of the colorant 14 may be from about 30 (kcal/mol) to about 100 (kcal/mol), or any range therein, per mole of the nanoparticle 12. The adsorption energy may be obtained by Equation 1.

$${E}_{ads} = {E}_{1} + {E}_{2} - {E}_{3} \qquad [ Equation 1 ]$$

In Equation 1, E₁ is the energy of the nanoparticle, E₂ is the energy of the colorant molecule, and E₃ is the energy of the state in which a colorant molecule is adsorbed on a nanoparticle.

In some embodiments, the molecular planarity parameter (MPP) value of the colorant 14 may be from about 0.1 to about 2.0, or any range therein, for example, from about 0.5 to about 1.8. In some embodiments, the span of deviation from plane (SDP) value of the colorant 14 may be from about 2.0 to about 7.0, or any range therein, for example, about 3.0 to about 6.0. Because the coloring composition for a color filter of the inventive concept includes the colorant 14 having a somewhat planar molecular structure, that is, the colorant 14 having relatively low MPP and SDP values, a relatively large adsorption amount and a relatively large adsorption energy may be obtained and thus, the obtained coloring composition for a color filter may have a stable energy state.

In embodiments, an Sᵣ value of the colorant 14 may be from about 0.3 to about 1.0, or any range therein, in which the Sᵣ value represents the ratio of the overlapping area between the highest occupied molecular orbital (HOMO) and the lowest unoccupied molecular orbital (LUMO). Intramolecular charge transfer (ICT) of the colorant 14 may affect the charge transfer of the nanoparticle 12. Since the Sᵣ value of the colorant 14 is relatively low, the overlap between the HOMO and LUMO is small, charge transfer within the molecule may easily occur, and thus charge transfer from the colorant 14 to the nanoparticle 12 may easily occur, which may contribute to radical generation and photocatalytic activity in the coloring composition for a color filter.

In some embodiments, the coloring composite 10 may be included in an amount of about 1 wt % to about 30 wt %, or any range therein, for example, about 3 wt % to about 25 wt %, based on the total amount of the coloring composition for a color filter.

In embodiments, the coloring composition for a color filter may further include a resin, a polymerizable monomer or oligomer, a polymerization initiator, and/or a solvent in any combination in addition to the coloring composite 10 including the nanoparticle 12 and the colorant 14 described with reference to FIG. 1.

### Resin

In embodiments, the resin may be either a thermoplastic or a thermosetting resin. In some embodiments, the resin may be an acrylic resin. In this regard, a copolymer of a first unsaturated monomer and a second unsaturated monomer may be the acrylic resin.

The first unsaturated monomer may be an ethylenically unsaturated monomer containing at least one carboxyl group, and for example, may be selected from the group consisting of acrylic acid, methacrylic acid, maleic acid, itaconic acid, fumaric acid, and combinations thereof.

In some embodiments, the second unsaturated monomer may be selected from the group consisting of an alkenyl aromatic monomer, an unsaturated carboxylic acid ester compound, an unsaturated carboxylic acid amino alkyl ester compound, a carboxylic acid vinyl ester compound, an unsaturated carboxylic acid glycidyl ester compound, a cyanide vinyl compound, an unsaturated amide compound, and combinations thereof. Examples of the alkenyl aromatic monomer include, but are not limited to, styrene, α-methyl styrene, vinyl toluene, vinyl benzyl methyl ether, etc.; examples of the unsaturated carboxylic acid ester compounds include, but are not limited to, methyl acrylate, methyl methacrylate, ethyl acrylate, ethyl methacrylate, butyl acrylate, butyl methacrylate, 2-hydroxy ethyl acrylate, 2-hydroxy ethyl methacrylate, 2-hydroxy butyl acrylate, 2-hydroxy butyl methacrylate, benzyl acrylate, benzyl methacrylate, cyclohexyl acrylate, cyclohexyl methacrylate, phenyl acrylate, phenyl methacrylate, etc.; examples of the unsaturated carboxylic acid amino alkyl ester compounds include, but are not limited to, 2-amino ethyl acrylate, 2-amino ethyl methacrylate, 2-dimethyl amino ethyl acrylate, 2-dimethyl amino ethyl methacrylate, etc.; examples of the carboxylic acid vinyl ester compounds include, but are not limited to, vinyl acetate, vinyl benzoate, etc.; examples of the unsaturated carboxylic acid glycidyl ester compounds include, but are not limited to, glycidyl acrylate, glycidyl methacrylate, etc.; examples of the cyanide vinyl compounds include, but are not limited to, acrylonitrile, methacrylonitrile, etc.; and examples of the unsaturated amide compounds include, but are not limited to, acrylamide, methacrylamide, etc. These second unsaturated monomers may be used alone or in combination of two or more.

Examples of the acrylic binder resin containing the first unsaturated monomer and the second unsaturated monomer include, but are not limited to, a methacrylic acid/benzyl methacrylate copolymer, a methacrylic acid/benzyl methacrylate/styrene copolymer, a methacrylic acid/benzyl methacrylate/2-hydroxy ethyl methacrylate copolymer, a methacrylic acid/benzyl methacrylate/styrene/2-hydroxy ethyl methacrylate copolymer, and the like, and these may be used alone or in combination of two or more thereof.

The weight ratio of the first unsaturated monomer may be about 10 wt % to about 40 wt %, or any range therein, for example 10 wt % to 30 wt %, 20 wt % to 40 wt %, 15 wt % to 30 wt %, based on the total weight of the acrylic binder resin.

In some embodiments, the weight average molecular weight (Mw) of the acrylic binder resin may be about 3,000 to about 150,000, or any range therein, for example, about 5,000 to about 50,000.

The acrylic binder resin may be included in an amount of about 1 wt % to about 30 wt %, or any range therein, for example, an amount of about 5 wt % to about 20 wt %, based on the total amount of the coloring composition for a color filter.

The acrylic binder resin is a factor that has the greatest influence on the resolution of pixels in the coloring composition for a color filter. For example, in the case of the methacrylic acid/benzyl methacrylate copolymer, the resolution of pixels may differ depending on the acid value and weight average molecular weight.

### Polymerizable Monomer or Oligomer

In embodiments, the polymerizable monomer or oligomer may be selected from the group consisting of thermally polymerizable monomers or photopolymerizable monomers or oligomers and combinations thereof, which are known in the art.

Examples of the polymerizable monomers are ethylene glycol di(meth)acrylate, diethylene glycol di(meth)acrylate, tricthylene glycol di(meth)acrylate, propylene glycol di(meth)acrylate, 1, 4-butanediol di(meth)acrylate, 1,6-hexanediol di(meth)acrylate, neopentyl glycol di(meth)acrylate, pentacrythritol di(meth)acrylate, pentaerythritol tri(meth)acrylate, pentacrythritol tetra(meth)acrylate, pentaerythritol penta(meth)acrylate, pentaerythritol hexa(meth)acrylate, dipentacrythritol di(meth)acrylate, dipentacrythritol tri(meth)acrylate, dipentacrythritol tetra(meth)acrylate, dipentacrythritol penta(meth)acrylate, dipentacrythritol hexa(meth)acrylate, bisphenol A di(meth)acrylate, trimethylolpropane tri(meth)acrylate, novolac epoxy (meth)acrylate, a dipentaerythritol penta(meth)acrylate derivative having a carboxyl group, ethylene oxide-modified glycerin trimethylolpropane tri(meth)acrylate, propylene oxide-modified glycerin tri(meth)acrylate, and combinations thereof.

In some embodiments, examples of the polymerizable oligomers are epoxy(meth)acrylate, urethane(meth)acrylate, and polyester(meth)acrylate oligomers.

Since the polymerizable monomers/oligomers tend to improve the solvent resistance by reacting with cyclic ethers, a monomer or oligomer which has a carboxyl group needs to be included. Examples of monomers having a carboxyl group or oligomers are esters of a hydroxyl group-containing methacrylate and a polyvalent carboxylic acid, esters of a hydroxyl group-containing methacrylate and a polyvalent carboxylic anhydride, etc.

Examples of commercially available products of the photopolymerizable monomer are as follows. Examples of the monofunctional esters of the (meth)acrylic acid are Aronix® M-101, Aronix® M-111, and Aronix® M-114 from Toagosei Chemical Industry Co., Ltd.; KAYARAD® TC-110S and KAYARAD® TC-120S from Nihon Kayaku Co., Ltd.; and V-158, and V-2311 from Osaka Yuki Chemical Industry Co., Ltd. Examples of the bifunctional esters of the (meth)acrylic acid are Aronix® M210, Aronix® M-240, and Aronix® M-6200 from Toagosci Chemical Industry Co., Ltd.; KAYARAD® HDDA, KAYARAD® HX-220, and KAYARAD® R-604 from Nihon Kayaku Co., Ltd.; and V-260, V-312, and V-335 HP from Osaka Yuki Chemical Industry Co., Ltd. Examples of the trifunctional ester of the methacrylic acid are Aronix® M-309, Aronix® M-400, Aronix® M-405, Aronix® M450, Aronix® M-7100, Aronix® M-8030, Aronix® M-8060, etc. from Toagosci Chemical Industry Co., Ltd.; KAYARAD® TMPTA, KAYARAD® DPCA-20, KAYARADR DPCA-30, KAYARAD® DPCA-60, KAYARAD® DPCA-120, etc. from Nihon Kayaku Co., Ltd.; and V-295, V-300, V-360, V-GPT, V-3PA, V-400, etc. from Osaka Yuki Kayaku Industry Co., Ltd. The products of the photopolymerizable monomers may be used alone or in combination of two or more.

The photopolymerizable monomer may also be used after being treated with an acid anhydride to provide better developing properties.

The photopolymerizable monomer may be included in an amount of about 1 wt % to about 15 wt %, or any range therein, for example, about 5 wt % to about 10 wt %, based on the total amount of the coloring composition for a color filter.

### Polymerization Initiator

In embodiments, the polymerization initiator may be a material selected from the group consisting of a thermal polymerization initiator, a photopolymerization initiator, and a combination thereof.

Examples of the thermal polymerization initiator are an organic peroxide and an azo compound, and these materials may be used alone or in combination of two or more of these.

Examples of the organic peroxide are isobutyl peroxide, 2,4-dichlorobenzoyl peroxide, α-methylbenzoyl peroxide, diisopropylbenzene hydroperoxide, cumene hydroperoxide, tert-butyl hydroperoxide, 1,1,3,3-tetramethylbutyl hydroperoxide, 2,5-dimethyl-2,5-ditert-butylperoxyhexane, 1,3-bistert-butylperoxyisopropylbenzene, dicumyl peroxide, di-tert-butyl peroxide, p-menthane hydroperoxide, tert-butylcumyl peroxide, di-tert-hexyl peroxide, tert-butylperoxy acetate, 2,4,4-trimethylpentylperoxyphenoxyacetate, t-butylperoxybenzoate, Examples of the azo compounds include 2,2-di-tert-butylperoxybutane, di-tert-methoxybutylperoxydicarbonate, di-2-ethylhexylperoxydicarbonate, and diisopropylperoxydicarbonate. Examples of the azo compounds include 1,1′;-azobiscyclohexane-1-carbonitrile, 2,2′;-azobis-2,4-dimethylvaleronitrile, 2,2′;-azobis-4-methoxy-2,4-dimethylvaleronitrile, 2,2′;-azobis-methylisobutyrate, 2,2′;-azobis-isobutyronitrile, 4,4′;-azobis-4-cyanovaleric acid, and the like.

In some embodiments, the photopolymerization initiator may be, for example, at least one selected from the group consisting of a triazine-based compound, an acetophenone-based compound, a bisimidazole-based compound, an active radical generator, and an acid generator, which are photopolymerization initiators commonly used in photosensitive resin compositions, but the initiator is not necessarily limited thereto.

In this regard, the active radical generator, e.g., radical polymerization initiator, may generate active radicals by irradiation with light. Examples of the active radical generators are a benzoin-based compound, a benzophenone-based compound, a thioxanthone-based compound, and an oxime-based compound.

As the polymerization initiator, a carbazole-based compound, a diketone-based compound, a sulfonium borate-based compound, and a diazo-based compound may be used in addition to the compounds listed above.

Examples of the photopolymerization initiator used in some embodiments are selected from the group consisting of 1-hydroxycyclohexyl-pentyl-ketone (Irgacure® 907), 2-methyl-1-[4-(methylthio)phenyl]-2-morpholinopropan-1-one (Irgacure® 184C), 2-hydroxy-2-methyl-1-phenyl-propan-1-one (Darocur® 1173), an initiator mixture of 50 wt % Irgacure® 184C and 50 wt % benzophenone (Irgacure® 500), an initiator mixture of 20 wt % Irgacure® and 80 wt % Darocur® 1173 (Irgacure® 1000), 2-hydroxy-1-[4-(2-hydroxyethoxy)phenyl]-2-methyl-1-propanone (Irgacure® 2959), methylbenzoylformate (Darocur® MBF), alpha, alpha-dimethoxy-alpha-phenylacetophenone (Irgacure® 651), 2-benzyl-2-(dimethylamino)-1-[4-(4-morpholinyl)phenyl]-1-butanone (Irgacure® 369), an initiator mixture of 30 wt % Irgacure® 369 and 70 wt % Irgacure® 651 (Irgacure® 1300), diphenyl(2,4,6-trimethylbenzoyl)-phosphine oxide (Darocur® TPO), an initiator mixture of 50 wt % Darocur® TPO and 50 wt % Darocur® 1173 (Darocur® 4265), phosphine oxide, phenyl bis(2,4,6-trimethyl benzoyl) (Irgacure® 819), an initiator mixture of 5 wt % Irgacure® 819 and 95 wt % Darocur® 1173 (Irgacure® 2005), an initiator mixture of 10 wt % Irgacure® 819 and 90 wt % Darocur® 1173 (Irgacure® 2010), an initiator mixture of 20 wt % Irgacure® 819 and 80 wt % Darocur® 1173 (Irgacure® 2020), bis(eta 5-2,4-cyclopentadien-1-yl) bis[2,6-difluoro-3-(1H-pyrrol-1-yl)phenyl] titanium (Irgacure® 784), and a initiator mixture containing benzophenone (HSP 188).

In some embodiments, the polymerization initiator may be used in combination with a photosensitizer that absorbs light, becomes excited, and then causes a chemical reaction by transferring energy.

The photopolymerization initiator may be included in an amount of about 0.1 wt % to about 10 wt %, or any range therein, for example, about 0.5 wt % to about 5 wt %, based on the total amount of the coloring composition for a color filter.

### Solvent

In embodiments, the solvent may be one that is compatible with, but does not react with, the acrylic resin and other component materials.

For example, examples of the solvent are alcohol compounds, such as methanol and ethanol; an ether compound, such as dichloroethyl ether, n-butyl ether, diisoamyl ether, methylphenyl ether, and tetrahydrofuran; a glycol ether compound, such as ethylene glycol monomethyl ether and ethylene glycol monoethyl ether; a cellosolve acetate compound, such as methyl cellosolve acetate, ethyl cellosolve acetate, and diethyl cellosolve acetate; a carbitol compound, such as methylethyl carbitol, diethyl carbitol, diethylene glycol monomethyl ether, diethylene glycol monoethyl ether, diethylene glycol dimethyl ether, diethylene glycol methylethyl ether, and diethylene glycol diethyl ether; a propylene glycol alkyl ether acetate compound, such as propylene glycol methyl ether acetate and propylene glycol propyl ether acetate; an aromatic hydrocarbon compound, such as toluene and xylene; a ketone compound, such as methyl ethyl ketone, cyclohexanone, 4-hydroxy-4-methyl-2-pentanone, methyl-n-propyl ketone, methyl-n-butyl ketonc, methyl-n-amyl ketone, and 2-heptanone; a saturated aliphatic monocarboxylic acid alkyl ester compound, such as ethyl acetate, n-butyl acetate, and isobutyl acetate; a monooxy monocarboxylic acid alkyl ester compound, such as 2-alkoxy-2-methyl propionic acid alkyl, a mono-carboxylic acid alkyl ester compound such as methyl 2-methyl propionate and ethyl 2-ethoxy-2-methyl propionate; N-methylformamide, N,N-dimethylformamide, N-methylformanilide, N-methylacetamide, N,N-dimethylacetamide, N-methylpyrrolidone, dimethyl sulfoxide, benzyl ethyl ether, and dihexyl ether. In some embodiments, the solvent may be a glycol ether compound, such as glycol ethylene glycol monoethyl ether, a cellosolve acetate compound, such as ethyl cellosolve acetate, an ester compound, such as ethyl 2-hydroxypropionate, a diethylene glycol compound, such as diethylene glycol monomethyl ether, and a propylene glycol alkyl ether acetate compound, such as propylene glycol methyl ether acetate, and propylene glycol propyl ether acetate.

In some embodiments, considering the solubility of the coloring composite, cyclohexanone may be included in an amount of about 10 wt % to about 50 wt %, or any range therein, based on the total amount of the solvent, for example, about 10 wt % to about 30 wt %, about 30 wt % to about 50 wt %.

The solvent may be used to appropriately adjust solubility and viscosity, and to provide advantageous physical and optical properties during product application, after adding other components with respect to the total amount of the coloring composition for a color filter.

The content of the solvent may be appropriately used within a range that provides excellent applicability and maintains flatness.

The solvent may be included in the remaining amount based on the total amount of the coloring composition for a color filter, and for example, may be included in an amount of about 20 wt % to about 90 wt %, or any range therein, for example, about 30 wt % to about 70 wt %, about 60 wt % to about 90 wt %, or about 20 wt % to about 50 wt %.

In embodiments, the coloring composition for a color filter of the inventive concept may include, based on 100 parts by weight of the coloring composite, a thermoplastic or thermosetting resin in an amount of about 100 parts by weight to about 1000 parts by weight, or any range therein, a polymerizable monomer or oligomer in an amount of about 30 parts by weight to about 500 parts by weight, or any range therein, a polymerization initiator in an amount of about 20 parts by weight to about 150 parts by weight, or any range therein, and a solvent in an amount from about 800 parts by weight to about 5,000 parts by weight, or any range therein. For example, the thermoplastic or thermosetting resin may be included, based on 100 parts by weight of the coloring composite, about 100 parts by weight to about 500 parts by weight, about 500 parts by weight to about 100 parts by weight, or about 300 parts by weight to about 700 parts by weight. In some embodiments, the polymerizable monomer or oligomer may be included, based on 100 parts by weight of the coloring composite, in an amount of about 30 parts by weight to about 100 parts by weight, about 200 parts by weight to about 500 parts by weight, or about 100 parts by weight to about 300 parts by weight. In some embodiments, the polymerizable initiator may be included, based on 100 parts by weight of the coloring composite, in an amount of about 20 parts by weight to about 75 parts by weight, about 75 parts by weight to about 150 parts by weight, or about 50 parts by weight to about 100 parts by weight. In some embodiments, the solvent may be included, based on 100 parts by weight of the coloring composite, about 800 parts by weight to about 2,000 parts by weight, about 2000 parts by weight to about 5,000 parts by weight, or about 1500 parts by weight to about 3000 parts by weight.

### Other Additives and Epoxy Compounds

The coloring composition for a color filter may further include other additives such as malonic acid; 3-amino-1,2-propanediol; a silane coupling agent containing a vinyl group or a methacryloxy group; a leveling agent; a fluorine-based surfactant; and a radical polymerization initiator, to prevent stains or spots during application, improve leveling performance, and prevent the generation of residues due to non-development.

Examples of the silane coupling agent are trimethoxysilyl benzoic acid, γ-methacryl oxypropyl trimethoxysilane, vinyl triacetoxysilane, vinyl trimethoxysilane, γ-isocyanate propyl tricthoxysilane, γ-glycidoxy propyl trimethoxysilane, β-3,4-epoxycyclohexylethyl trimethoxysilane, etc., and these may be used alone or in combination of two or more.

Examples of the fluorine-based surfactant (e.g., fluorinated surfactants) are commercial products such as BM-1000, BM-1100, etc. from BM Chemie; Megaface® F-142D, Megaface® F-172, Megaface® F-173, Megaface® F-183, etc. from Dainippon Ink and Chemicals, Inc.; Fluorad® FC-135, Fluorad® FC-170C, Fluorad® FC-430, Fluorad® FC-431, etc. from Sumitomo 3M, Inc.; Surflon S-112, Surflon S-113, Surflon S-131, Surflon S-141, Surflon S-145, etc. from Asahi Glass Co., Ltd.; and SH-28PA, SH-190, SH-193, SZ-6032, SF8428, etc. from Toray Silicone Co., Ltd.

The amount of the additives may be easily adjusted according to the desired properties.

The coloring composition for a color filter may further include an epoxy compound to improve adhesion to a substrate, etc.

Examples of the epoxy compound are a phenol novolac epoxy compound, a tetramethyl biphenyl epoxy compound, a bisphenol A type epoxy compound, an alicyclic epoxy compound, or a combination thereof. The epoxy compound may be included in an amount from about 0.01 parts by weight to about 5 parts by weight, or any range therein, for example, from about 0.1 parts by weight to about 5 parts by weight, based on 100 parts by weight of the coloring composition for a color filter. When the epoxy compound is included within the range, the adhesion, heat resistance, and chemical resistance are excellent.

### Color Filter

A color filter may be manufactured using the coloring composition for a color filter described above. In an embodiment, when the coloring composition for a color filter described above includes a photosensitive composition, the method of manufacturing the color filter is as follows.

The coloring composition for a color filter is applied to a thickness of from about 3.1 μm to about 3.4 μm, or any range therein, by using an appropriate method such as spin coating or slit coating on a glass substrate having no coating or on a glass substrate coated with SiNx as a protective film to a thickness of from about 500 Å to about 1500 Å, or any range therein. After applying the coloring composition for a color filter, light is irradiated to form the pattern required for the color filter.

After irradiating with light, the coating layer is treated with an alkaline developer, causing the unirradiated portion of the coating layer to dissolve and forming a pattern required for a color filter. By repeating this process according to the required number of reds, a color filter having a desired pattern may be obtained. In addition, during the manufacturing process, crack resistance, solution resistance, etc. may be further enhanced by reheating the image pattern obtained by development or hardening the same by active line irradiation, etc.

The coloring composition for a color filter according to embodiments of the inventive concept may include the coloring composite 10, and the coloring composite 10 includes the nanoparticle 12. Accordingly, reliability may be secured by having relatively high photostability and heat stability. Also, since the colorant 14 is adsorbed on the surface of the nanoparticle 12, transmittance and dispersibility are relatively high and light scattering is low, and thus optical properties can be obtained. Therefore, when the coloring composite 10 is used, a coloring composition for a color filter with optical properties and enhanced photostability and heat stability can be provided.

Hereinafter, a method of manufacturing the nanoparticle 12, a method of manufacturing the colorant 14, and a method of manufacturing the coloring composite 10 by adsorbing the colorant 14 on the surface of the nanoparticle 12 will be described through experimental examples.

### EXPERIMENTAL EXAMPLES

First, a method of manufacturing anatase phase titanium dioxide nanoparticles and rutile phase titanium dioxide nanoparticles as the nanoparticle 12 will be described.

Anatase phase titanium dioxide nanoparticles are prepared through hydrolysis, precipitation, and hydrothermal synthesis processes. Hydrolysis is carried out by dripping titanium chloride into an aqueous sulfuric acid solution in an ice bath. A precursor solution is heated to reach 80 degrees Celsius, and then, ammonium hydroxide aqueous solution is added thereto and stirred. After cooling the precipitation solution to room temperature, washing is performed three times using deionized water. The precursor solution dispersed in deionized water is placed in a Teflon-lined autoclave and heat-treated at 100 degrees Celsius for 12 hours to carry out hydrothermal synthesis. Thereafter, the reaction precipitate may be filtered through a centrifuge and dried through vacuum evaporation to obtain titanium dioxide nanoparticles in the anatase phase.

Rutile phase titanium dioxide nanoparticles are manufactured through hydrolysis and hydrothermal synthesis processes. Hydrolysis is carried out by dropping titanium chloride into an aqueous sulfuric acid solution in an ice bath. The precursor solution dispersed in deionized water is placed in a Teflon-lined autoclave and heat-treated at 100 degrees Celsius for 12 hours to carry out hydrothermal synthesis. Thereafter, the reaction precipitate may be filtered through a centrifuge and dried through vacuum evaporation to obtain titanium dioxide nanoparticles in the rutile phase.

Hereinafter, a method of manufacturing a perylene compound represented by Formula 2, a diketopyrrolopyrrole compound represented by Formula 3, and an azo compound represented by Formula 4 as the colorant 14 are sequentially described with reference to Reaction Scheme 1, Reaction Scheme 2, and Reaction Scheme 3, respectively.

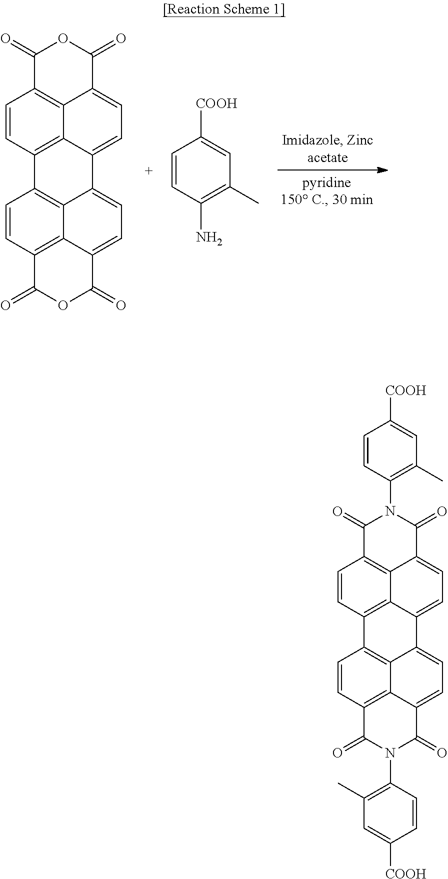 [SMILES: O=C1OC(=O)c2ccc3c4ccc5c6c(ccc(c7ccc1c2c73)c64)C(=O)OC5=O ; Cc1cc(C(=O)O)ccc1N ; Cc1cc(C(=O)O)ccc1N1C(=O)c2ccc3c4ccc5c6c(ccc(c7ccc(c2c37)C1=O)c64)C(=O)N(c1ccc(C(=O)O)cc1C)C5=O]

3,4,9,10-perylene tetracarboxylic dianhydride, (C₂₄H₈O₆), imidazole (C₃N₂H₄), zinc acetate (ZnC₄H₆O₄), pyridine (C₅H₅N) were mixed and stirred at 150 degrees Celsius for 30 minutes. After the reaction is complete, the mixture was cooled to room temperature to precipitate the product. Afterwards, the precipitate that has gone through the filtration process was washed with ethanol, and the solvent was evaporated under vacuum to obtain a perylene compound represented by Formula 2.

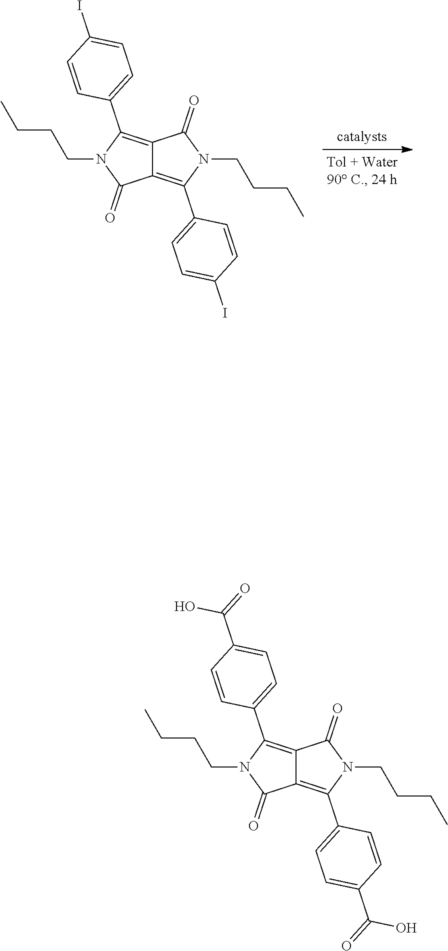

The precursor consisting of diketopyrrolopyrrole, C₆H₂N₂O₂), palladium acetate (Pd(CH₃COO)₂), xantphos (C₃₉H₃₂OP₂), 4-dimethylaminopyridine, ((CH₃)₂NC₅H₄N), cobalt carbonyl (Co₂(CO)₈), toluene (C₆H₅CH₃), and water was sealed and then stirred at 90 degrees Celsius for 20 hours. When the reaction was complete, the resultant mixture was cooled to room temperature. The mixture was slowly added dropwise to an aqueous citric acid solution and then extracted with ethyl acetate. Thereafter, the combined organic layer was dried using anhydrous magnesium sulfate and vacuum evaporation. The byproduct was purified through column chromatography using a dichloromethane:methanol mixed solution to obtain a diketopyrrolopyrrole compound represented by Formula 3.

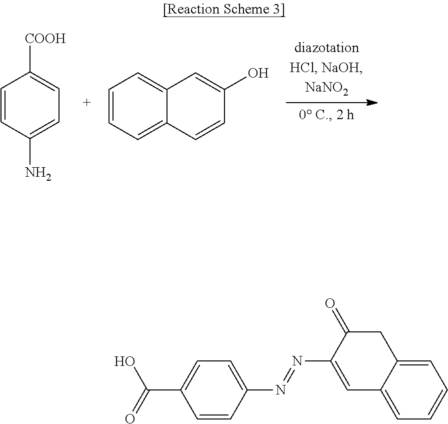 [SMILES: Nc1ccc(C(=O)O)cc1 ; Oc1ccc2ccccc2c1 ; O=C1Cc2ccccc2C=C1/N=N/c1ccc(C(=O)O)cc1]

4-aminobenzoic acid (C₇H₇NO₂) was added to a mixture of concentrated hydrogen chloride (HCl) and water and stirred in an ice bath. The cooled mixture was slowly dropped into a solution of sodium nitrite and water and then stirred. Afterwards, 2-naphthol was dissolved in an aqueous sodium hydroxide solution to prepare a coupling agent. The manufactured diazonium salt was slowly dropped into the coupling agent and stirred at 0 degrees Celsius for 1 hour. Afterwards, the product may be filtered and vacuum dried, and then precipitated with a mixed solution of acetic acid and water to obtain an azo compound represented by Formula 4.

Next, a method of manufacturing a solution containing the coloring composite 10 by adsorbing the colorant 14 on the surface of nanoparticle 12 is described.

First, the dye powder containing the perylene compound, the diketopyrrolopyrrole compound, and the azo compound was dissolved in a methyl ethyl ketone solution and titanium dioxide nanoparticles were added thereto. One day after stirring of the resulting mixture, polytetrafluoroethylene (PTFE) was dissolved in the solution, and then the mixture was filtered using a syringe filter (pore size of about 0.2 μm) to remove residual aggregates, thereby obtaining a coloring composition in which a colorant is adsorbed on titanium dioxide nanoparticles.

Finally, a method of manufacturing a thin film using the coloring composition is described.

The coloring composition was added to a filtered solution of polymethyl methacrylate or polystyrene-polymethyl methacrylate polymer binder, and then dropped onto a glass substrate. Then, the glass substrate was heat-treated on a hot plate at 85 degrees Celsius for about 1 minute, thereby obtaining a thin film.

Hereinafter, the properties of titanium dioxide nanoparticles as the nanoparticle 12 formed through the experimental example and perylene compounds, diketopyrrolopyrrole compounds and azo compounds as the colorant 14 adsorbed onto the titanium dioxide nanoparticles are described. The perylene compound may be a compound represented by Formula 2, the diketopyrrolopyrrole compound may be a compound represented by Formula 3, and the azo compound may be a compound represented by Formula 4.

The adsorption amounts of the perylene compound, the diketopyrrolopyrrole compound, and the azo compound are as shown in Table 1 below.

TABLE 1

| | Perylene | Diketopyrrolopyrrole | Azo |
|---|---|---|---|
| | compound | compound | compound |
| Adsorption amount | 0.013 | 0.007 | 0.020 |
| (mM/g) | | | |
| Chemical adsorption | 0.0087 | 0.0049 | 0.012 |
| (mM/g) | | | |
| Physical adsorption | 0.0043 | 0.0021 | 0.0076 |
| (mM/g) | | | |

Referring to Table 1 above, it can be seen that azo compounds have a relatively large adsorption amount. Additionally, it can be seen that the chemical adsorption amount is relatively large compared to the physical adsorption amount.

The adsorption energy of each of the perylene compound, the diketopyrrolopyrrole compound, and the azo compound are as shown in Table 2 below.

TABLE 2

| | Perylene | Diketopyrrolopyrrole | Azo |
|---|---|---|---|
| | compound | compound | compound |
| Adsorption energy | 41.1 | 37.0 | 78.2 |
| (kcal/mol) | | | |

Referring to Table 2, it can be seen that the adsorption energy of the diketopyrrolopyrrole compound is relatively low, and specifically, it can be seen that the adsorption energy gradually increases in the order of the diketopyrrolopyrrole compound, the perylene compound, and the azo compound. That is, it can be seen that the coloring composite is stable in the order of the structure in which the diketopyrrolopyrrole compound is adsorbed on the titanium dioxide nanoparticle, the structure in which the perylene compound is adsorbed on the titanium dioxide nanoparticle, and the structure in which the azo compound is adsorbed on the titanium dioxide nanoparticle.

The MPP values and the SDP values of each of the perylene compound, the diketopyrrolopyrrole compound, and the azo compounds are as shown in Table 3 below.

TABLE 3

| | Perylene | Diketopyrrolopyrrole | Azo |
|---|---|---|---|
| | compound | compound | compound |
| MPP | 1.186 | 1.560 | 0.766 |
| SDP | 5.433 | 5.949 | 3.209 |

Referring to Table 3 above, it can be seen that the azo compound has the most planar structure and the diketopyrrolopyrrole compound has the most distorted structure.

The Sᵣ value of each of the perylene compound, the diketopyrrolopyrrole compound, and the azo compound is as shown in Table 4 below.

TABLE 4

| | Perylene | Diketopyrrolopyrrole | Azo |
|---|---|---|---|
| | compound | compound | compound |
| Sr | 0.9 | 0.81 | 0.39 |

Referring to Table 4, it can be seen that the Sᵣ value of the azo compound is relatively low, and specifically, it can be seen that the Sᵣ value gradually increases in the order of the azo compound, the diketopyrrolopyrrole compound, and the perylene compound.

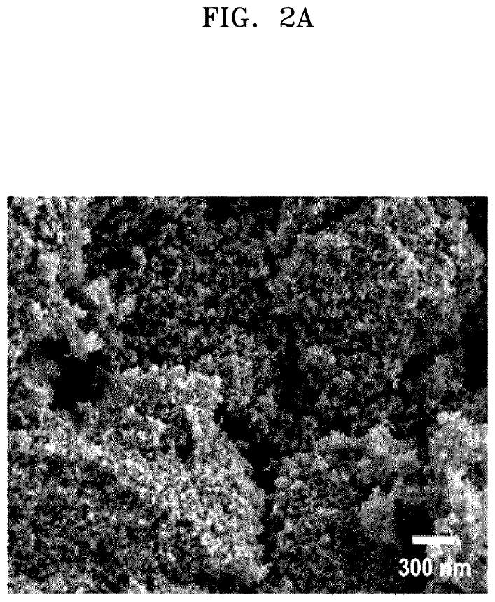

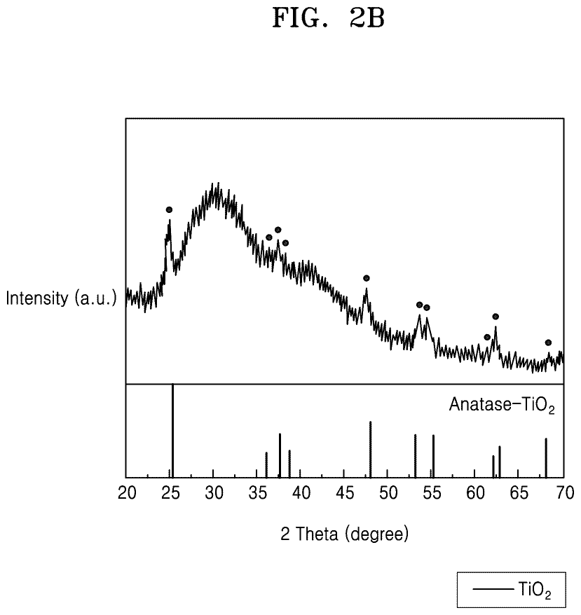

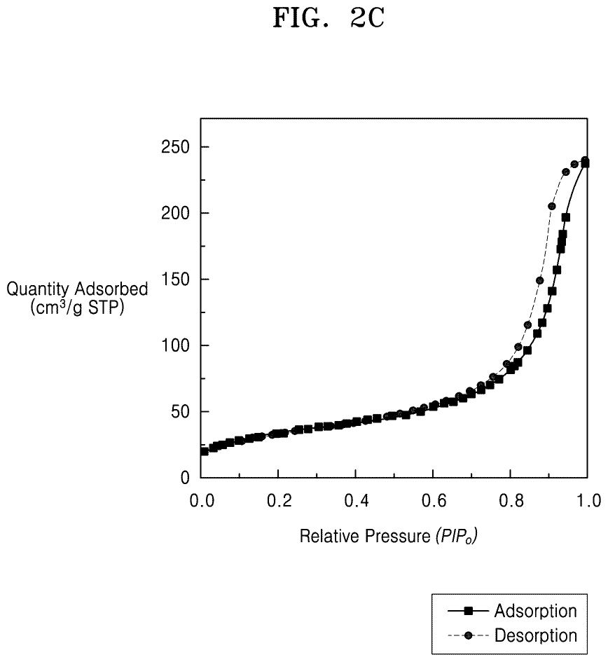

FIGS. 2A, 2B and 2C show diagrams for explaining the anatase phase of nanoparticles included in the coloring composition for a color filter of the inventive concept.

Specifically, FIG. 2A shows a scanning electron microscope (SEM) image of anatase-phase nanoparticles, FIG. 2B shows an X-ray diffraction (XRD) spectrum of anatase-phase nanoparticles, and FIG. 2C shows a surface area Brunauer-Emmett-Teller (BET) analysis result of anatase-phase nanoparticles.

Referring to FIGS. 2A, 2B, and 2C, it can be seen that the anatase phase nanoparticles are formed in a spherical shape, have an average particle diameter of about 25 nanometers, and have a specific surface area of about 115 m²/g to 125 m²/g, with an average specific surface area of about 118.79 m²/g.

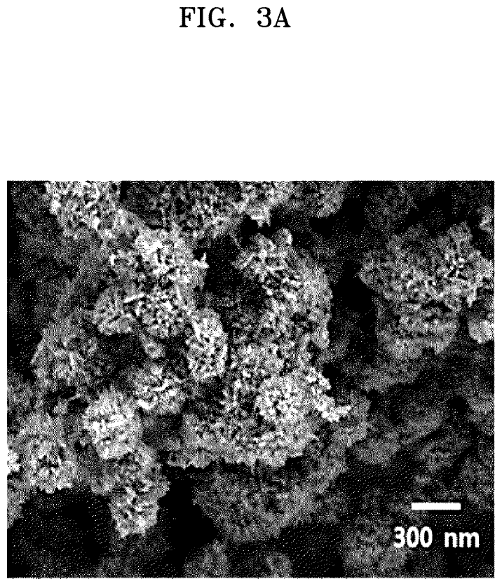

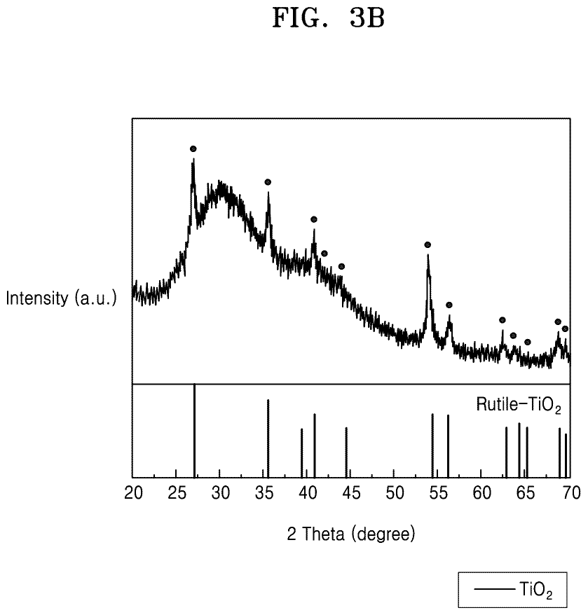

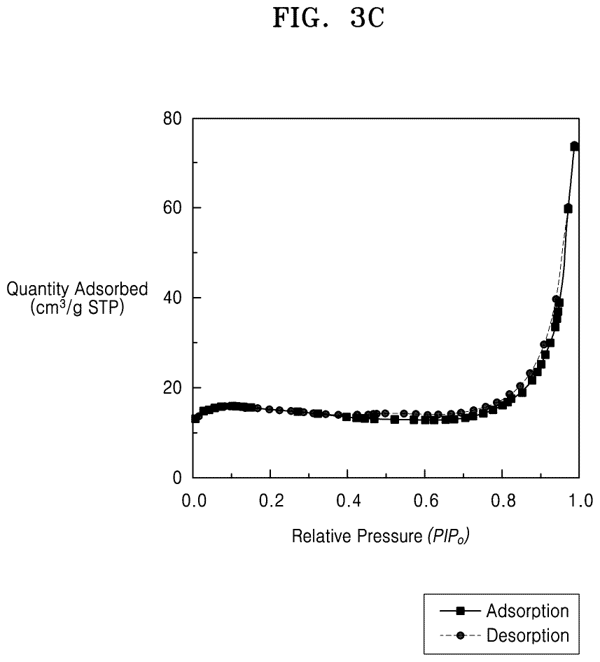

FIGS. 3A, 3B, and 3C show diagrams for explaining the rutile phase of nanoparticles included in the coloring composition for a color filter of the inventive concept.

Specifically, FIG. 3A shows an SEM image of rutile phase nanoparticles, FIG. 3B shows an XRD spectrum of rutile phase nanoparticles, and FIG. 3C shows a BET analysis result of rutile phase nanoparticles.

Referring to FIGS. 3A, 3B, and 3C, it can be seen that the rutile phase nanoparticles are formed in a spherical shape, have an average particle diameter of about 34 nanometers, and have a specific surface area of about 35 m²/g to about 55 m²/g, with an average specific surface area of about 45.27 m²/g.

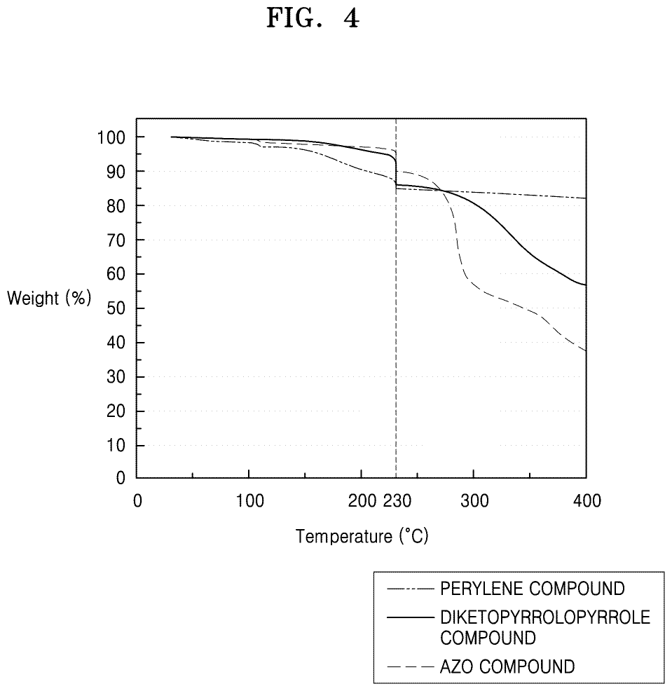

FIGS. 4, 5, 6, 7A and 7B are graphs for explaining the properties according to the type of colorant included in the coloring composition for a color filter of the inventive concept. Hereinafter, by way of example, the perylene compound may be the compound represented by Formula 2 described above, the diketopyrrolopyrrole compound may be the compound represented by Formula 3 described above, and the azo compound may be the compound represented by Formula 4 described above.

In addition, a thin film including each of the perylene compound adsorbed on titanium dioxide nanoparticles, the diketopyrrolopyrrole compound adsorbed on titanium dioxide nanoparticles, and the azo compound adsorbed on titanium dioxide nanoparticles below may be a thin film manufactured from the coloring composition of the inventive concept through the manufacturing method described above in the experimental example. In this regard, the thickness of the thin film was about 0.05 mm, the concentration of each of the perylene compound, the diketopyrrolopyrrole compound, and the azo compound was about 0.7 mM, and about 2 mg of titanium dioxide and about 5 ml of methylethyl ketone were used.

FIG. 4 shows a graph for explaining the results of thermal gravimetric analysis (TGA) of the coloring composition for a color filter of the inventive concept.

Referring to FIG. 4, it can be seen that the perylene compound, the diketopyrrolopyrrole compound, and the azo compound show relatively small mass changes under 230 degrees Celsius, and in particular, the perylene compound shows a mass change of less than about 5 wt %, indicating that the perylene compound has relatively high thermal stability.

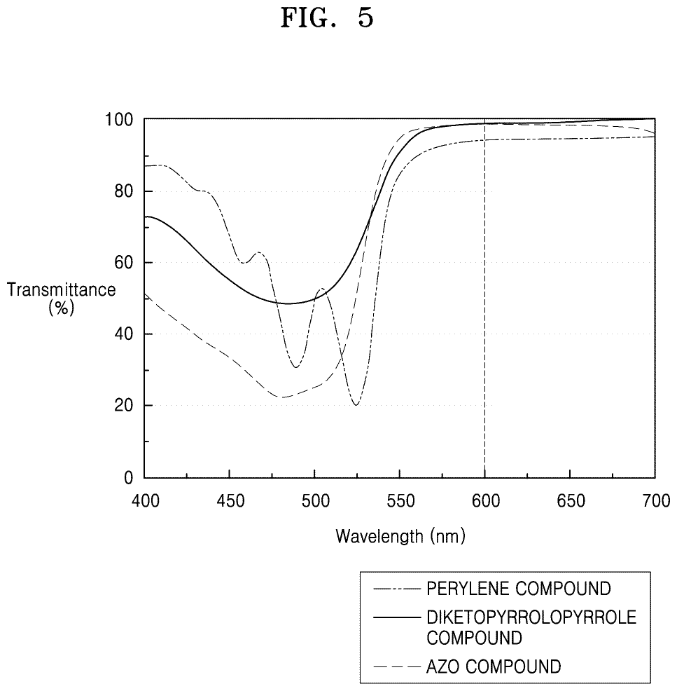

FIG. 5 shows a graph showing the transmittance spectrum of the coloring composition for a color filter of the inventive concept.

Specifically, at a wavelength of 600 nanometers, the transmittance of a thin film including the perylene compound adsorbed on titanium dioxide nanoparticles was confirmed to be about 93.9%, the transmittance of a thin film including the diketopyrrolopyrrole compound adsorbed on titanium dioxide nanoparticles was confirmed to be about 98.7%, and the transmittance of a thin film including the azo compound adsorbed on titanium dioxide nanoparticles was confirmed to be about 98.4%. Since the thin film has a transmittance of 90% to 100% at a wavelength of 600 nanometers, it may be used as a red color filter.

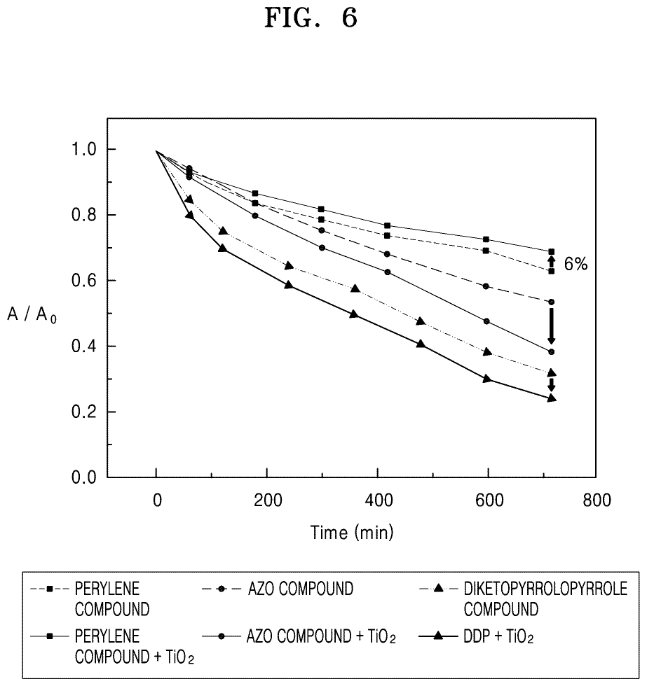

FIG. 6 is a graph showing the relative absorbance over time of a coloring composition for a color filter containing only the coloring composite or colorant of the inventive concept.

FIG. 6 shows the relative absorbance, which is the ratio of the absorbance A after irradiating with light for 0 minutes to 800 minutes to the initial absorbance Ao of a thin film including each of the perylene compound, the diketopyrrolopyrrole (DDP) compound, and an azo compound adsorbed on titanium dioxide nanoparticles.

The relative absorbance of the thin film including each of the perylene compound adsorbed on the titanium dioxide nanoparticles, the diketopyrrolopyrrole compound adsorbed on the titanium dioxide nanoparticles, and the azo compound adsorbed on the titanium dioxide nanoparticles, as shown in FIG. 6, was expressed as the average value when 2 mg, 4 mg, and 8 mg of titanium dioxide nanoparticles were included, and the relative absorbance of the thin films including only the perylene compound, the dikctopyrrolopyrrole compound, and the azo compound was expressed as the value corresponding to the case where 0 mg of titanium dioxide nanoparticles were included. It can be seen that the photostability of a thin film containing a perylene compound adsorbed on titanium dioxide nanoparticles was improved by about 6% compared to the photostability of a thin film containing a perylene compound alone without titanium dioxide nanoparticles.

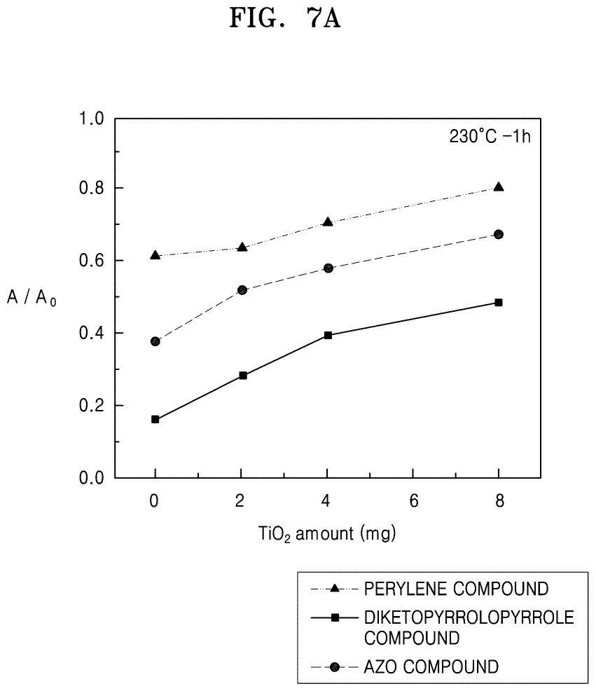

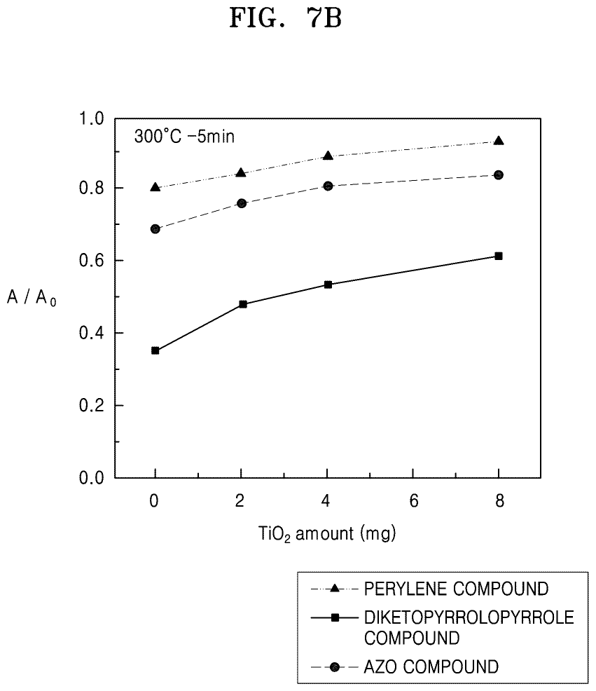

FIG. 7A and FIG. 7B show graphs of measurements the relative absorbance according to the temperature of the coloring composition for a color filter of the inventive concept.

FIG. 7A shows the relative absorbance, which is the ratio of the absorbance A after maintaining at about 230 degrees Celsius for about 1 hour to the initial absorbance Ao of a thin film including each of the perylene compound adsorbed on titanium dioxide nanoparticles, the diketopyrrolopyrrole compound adsorbed on titanium dioxide nanoparticles, and the azo compound adsorbed on titanium dioxide nanoparticles, and FIG. 7B shows the relative absorbance, which is the ratio of the absorbance A after maintaining at about 300 degrees Celsius for about 5 minutes to the initial absorbance Ao of a thin film including each of the perylene compound adsorbed on titanium dioxide nanoparticles, the diketopyrrolopyrrole compound adsorbed on titanium dioxide nanoparticles, and the azo compound adsorbed on titanium dioxide nanoparticles.

As shown in FIGS. 7A and 7B, compared to the case of a thin film including each of the perylene compound, the diketopyrrolopyrrole compound, and the azo compound alone without titanium dioxide nanoparticles, it can be seen that the thin film including each of the perylene compound, the diketopyrrolopyrrole compound, and the azo compound, adsorbed on titanium dioxide nanoparticles has a relatively improved relative absorbance and a relatively high thermal stability.

As described above, embodiments have been disclosed in the drawings and specifications. Although specific terms have been used in the present specification to describe embodiments, they have been used only for the purpose of explaining the technical idea of the inventive concept and are not intended to limit the meaning or the scope of the inventive concept described in the claims. Therefore, a person having ordinary skill in the art will understand that various modifications and equivalent other embodiments are possible therefrom. Therefore, the true technical protection scope of the inventive concept should be determined by the technical idea of the appended claims.

What is claimed is:

1. A coloring composition for a color filter, the coloring composition comprising:
a coloring composite comprising a colorant adsorbed on a surface of a nanoparticle, the nanoparticle comprising metal oxide or non-metal oxide, wherein
the colorant comprises one selected from a perylene compound including a carboxyl group (—COOH) at a para position of a benzene ring, a diketopyrrolopyrrole compound including a carboxyl group (—COOH) at a para position of a benzene ring, and an azo compound including a carboxyl group (—COOH) at a para position of a benzene ring.

2. The coloring composition of claim 1, wherein
the colorant comprises a compound represented by Formula 1: 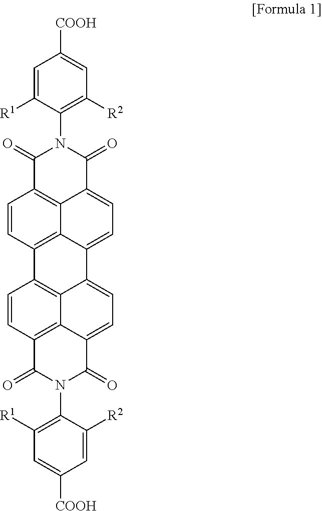
wherein R¹ and R² in Formula 1 each independently represent hydrogen or a C1 to C4 alkyl group.

3. The coloring composition of claim 1, wherein
the colorant comprises a compound represented by one of Formula 2, Formula 3, and Formula 4:

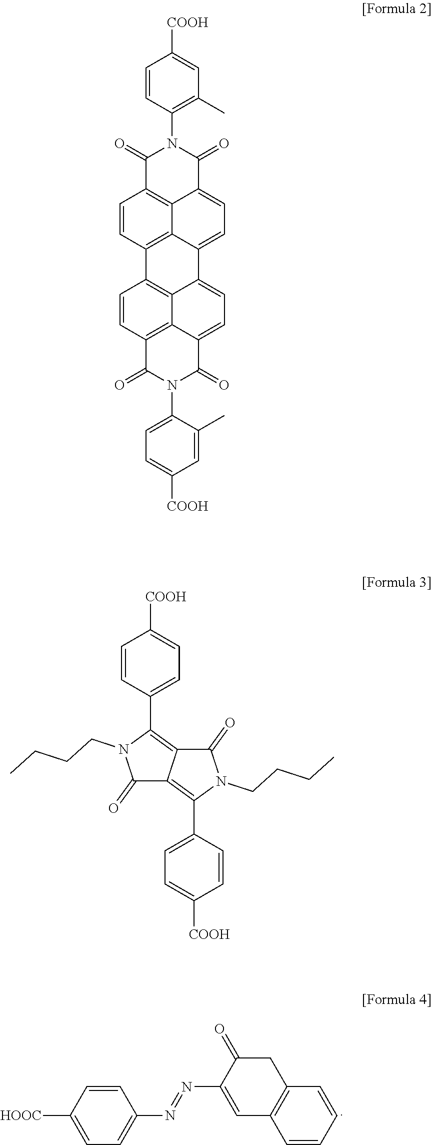 [SMILES: Cc1cc(C(=O)O)ccc1N1C(=O)c2ccc3c4ccc5c6c(ccc(c7ccc(c2c37)C1=O)c64)C(=O)N(c1ccc(C(=O)O)cc1C)C5=O ; CCCCN1C(=O)C2=C(c3ccc(C(=O)O)cc3)N(CCCC)C(=O)C2=C1c1ccc(C(=O)O)cc1 ; O=C1Cc2ccccc2C=C1/N=N/c1ccc(C(=O)O)cc1]

4. The coloring composition of claim 1, wherein
the coloring composite has a transmittance of about 85% to about 100% in a wavelength range of about 550 nm to about 750 nm.

5. The coloring composition of claim 1, wherein
the nanoparticle comprises titanium dioxide.

6. The coloring composition of claim 1, wherein
the nanoparticle has a radius of about 0.01 nanometers to about 15 nanometers.

7. The coloring composition of claim 1, further comprising
a solvent, wherein
the coloring composite is individually dispersed in the solvent.

8. The coloring composition of claim 1, wherein
the colorant is adsorbed at about 0.001 (mM/g) to 0.05 (mM/g) per mass of the nanoparticle.

9. The coloring composition of claim 1, wherein
the coloring composite comprises a first structure in which the colorant is disposed horizontally on the surface of a first nanoparticle and a second structure in which the colorant is disposed vertically on the surface of a second nanoparticle.

10. The coloring composition of claim 1,
further comprising:
an acrylic binder resin;
a polymerizable monomer;
a polymerization initiator; and
a solvent.

11. The coloring composition of claim 10, wherein
the acrylic binder resin comprises a methacrylic acid/benzyl methacrylate copolymer, a methacrylic acid/benzyl methacrylate/styrene copolymer, a methacrylic acid/benzyl methacrylate/2-hydroxy ethyl methacrylate copolymer, a methacrylic acid/benzyl methacrylate/styrene/2-hydroxy ethyl methacrylate copolymer, or a combination thereof.

12. The coloring composition of claim 10, wherein
the polymerizable monomer comprises ethylene glycol di(meth)acrylate, diethylene glycol di(meth)acrylate, triethylene glycol di(meth)acrylate, propylene glycol di(meth)acrylate, 1, 4-butanediol di(meth)acrylate, 1,6-hexanediol di(meth)acrylate, neopentyl glycol di(meth)acrylate, pentaerythritol di(meth)acrylate, pentaerythritol tri(meth)acrylate, pentaerythritol tetra(meth)acrylate, pentaerythritol penta(meth)acrylate, pentaerythritol hexa(meth)acrylate, dipentaerythritol di(meth)acrylate, dipentaerythritol tri(meth)acrylate, dipentaerythritol tetra(meth)acrylate, dipentaerythritol penta(meth)acrylate, dipentaerythritol hexa(meth)acrylate, bisphenol A di(meth)acrylate, trimethylolpropane tri(meth)acrylate, novolac epoxy (meth)acrylate, a dipentaerythritol penta(meth)acrylate derivative having a carboxyl group, ethylene oxide-modified glycerin trimethylolpropane tri(meth)acrylate, propylene oxide-modified glycerin tri(meth)acrylate, epoxy (meth)acrylate, urethane (meth)acrylate, polyester (meth)acrylate oligomer, or a combination thereof.

13. The coloring composition of claim 1, further comprising
an additive selected from: malonic acid; 3-amino-1,2-propanediol; a silane coupling agent containing a vinyl group or a methacryloxy group; a leveling agent; a fluorinated surfactant; a radical polymerization initiator; or a combination thereof.

14. A color filter for an image sensor manufactured from the coloring composition for a color filter according to claim 1.

15. A method of manufacturing a coloring composition for a color filter, the method comprising:
providing a nanoparticle containing titanium dioxide;
providing a colorant; and
synthesizing a coloring composite in which the colorant is adsorbed on a surface of the nanoparticle, wherein
the colorant comprises a compound represented by one of Formula 2, Formula 3, and Formula 4:

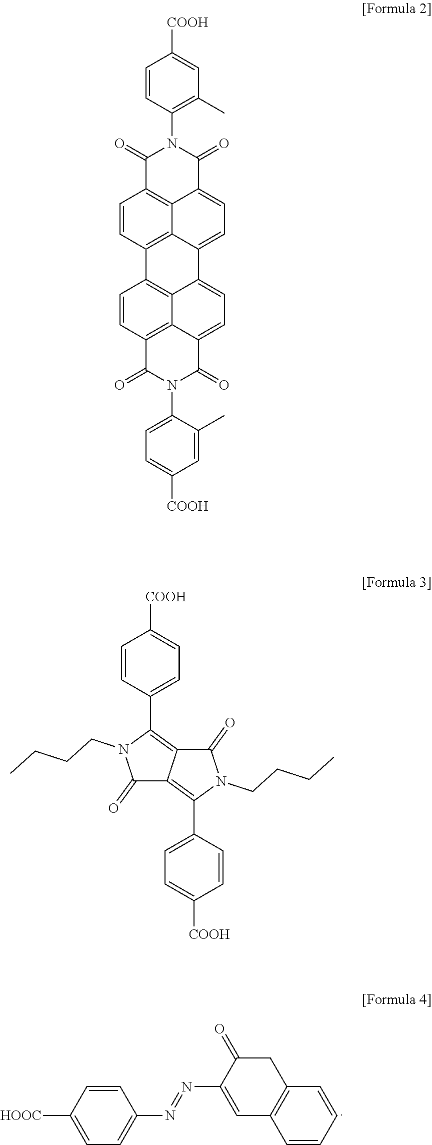 [SMILES: Cc1cc(C(=O)O)ccc1N1C(=O)c2ccc3c4ccc5c6c(ccc(c7ccc(c2c37)C1=O)c64)C(=O)N(c1ccc(C(=O)O)cc1C)C5=O ; CCCCN1C(=O)C2=C(c3ccc(C(=O)O)cc3)N(CCCC)C(=O)C2=C1c1ccc(C(=O)O)cc1 ; O=C1Cc2ccccc2C=C1/N=N/c1ccc(C(=O)O)cc1]

16. The method of claim 15, wherein
the providing the nanoparticle comprises synthesizing the nanoparticle, comprising:
hydrolyzing titanium chloride by reacting the same with a sulfuric acid aqueous solution; and
hydrothermally synthesizing a titanium chloride solution in which the titanium chloride is mixed with the sulfuric acid aqueous solution by heat treatment.

17. The method of claim 15, wherein
the providing the nanoparticle comprises synthesizing the nanoparticle, comprising:
hydrolyzing titanium chloride by reacting the same with a sulfuric acid aqueous solution;
adding an ammonium hydroxide aqueous solution to a first titanium chloride solution in which the titanium chloride is mixed with the sulfuric acid aqueous solution to cause precipitation; and
performing hydrothermal synthesis by heat-treating a second titanium chloride solution prepared by adding ammonium hydroxide to the first titanium chloride solution.

18. The method of claim 15, wherein
the synthesizing the coloring composite comprises:
adding the nanoparticle and the colorant to a solvent and stirring the result, wherein the colorant is adsorbed on the surface of the nanoparticle at about 0.001 (mM/g) to 0.05 (mM/g) per mass of the nanoparticle.

19. A coloring composition for a color filter, the coloring composition comprising:
a nanoparticle comprising titanium dioxide; and
a colorant adsorbed on a surface of the nanoparticle, wherein
the colorant comprises a compound represented by any one of Formula 2, Formula 3 and Formula 4,
the coloring composite has a transmittance of about 85% to about 100% in a wavelength range of about 550 nm to about 750 nm:

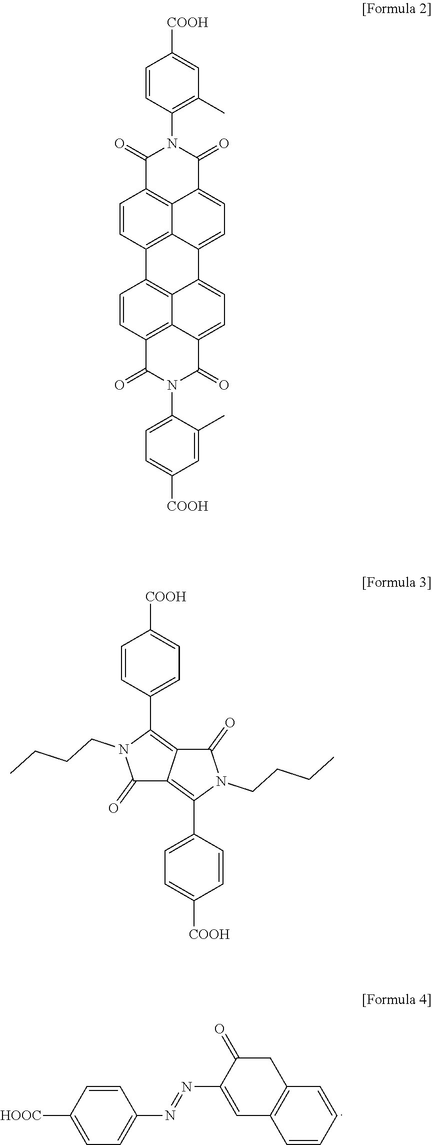 [SMILES: Cc1cc(C(=O)O)ccc1N1C(=O)c2ccc3c4ccc5c6c(ccc(c7ccc(c2c37)C1=O)c64)C(=O)N(c1ccc(C(=O)O)cc1C)C5=O ; CCCCN1C(=O)C2=C(c3ccc(C(=O)O)cc3)N(CCCC)C(=O)C2=C1c1ccc(C(=O)O)cc1 ; O=C1Cc2ccccc2C=C1/N=N/c1ccc(C(=O)O)cc1]

20. The coloring composition of claim 19,
further comprising:
an acrylic binder resin;
a photopolymerizable monomer;
a photopolymerization initiator; and
a solvent.
